(19) United States
(12) Patent Application Publication
(10) Pub. No.: US 2012/0298533 A1
(43) Pub. Date: Nov. 29, 2012

(54) GAS CYLINDER, AND A METHOD FOR PROVIDING SUCH A CYLINDER

(75) Inventor: Mikael Sahlström, Malmo (SE)

(73) Assignee: Intravalve AB, Vaxholm (SE)

(21) Appl. No.: 13/575,867

(22) PCT Filed: Jan. 28, 2011
(86) PCT No.: PCT/SE2011/050094

§ 371 Date: Jul. 27, 2012

(30) Foreign Application Priority Data
Jan. 28, 2010 (SE) 1050091-6
Mar. 5, 2010 (SE) 1000211-1

(51) Int. Cl. B65D 85/00; B23P 15/00

(52) U.S. Cl. 206/6; 29/428

(57) ABSTRACT

A cylinder (10) for storing pressurized fluid is provided, comprising a hollow body (12) formed integrally with a closed bottom end (14) and a closed upper end (16), a valve (20, 200) having a valve body (24, 205) and an actuator (22, 220), said valve (20, 200) being arranged at said upper end (16) for allowing gas charging and gas discharging, respectively, wherein said valve (20, 200) is mounted on the inside of said cylinder (10) such that the interior surface of said upper end (16) is sealed against said valve body (24, 205), and such that said actuator (22, 220) is extending outside said cylinder (10).

### FIELD OF THE INVENTION

The present invention relates to a gas cylinder, and to a method for providing such gas cylinder.

### BACKGROUND

For storing pressurized fluid, a cylinder or cartridge may be used. Such cylinder must be constructed to secure that no gas is leaking out from the cylinder. For this purpose, a typical cylinder comprises a hollow tube, having a closed bottom end and a semi-closed upper end. The upper end has an opening, in which a valve is fitted. The valve has two functions, i.e. to allow filling of the cylinder, and to allow discharge of gas out from the cylinder.

If the gas is cooled down before storing, the cylinder may also be provided with a reflective surface on the inside, as well as a vacuum space arranged around the cylinder for reducing heat transfer between the enclosed gas and the outer environment.

For example, JP-8,117,904 describes a gas cylinder having a tubular body and a closed bottom end having a spherical shape. The upper end is closed by a necking process, in which a die is pressed downwards to form a domed shape of the upper end of the cylinder. A valve may then be attached to the upper end, for allowing charging of gas into the cylinder.

In particular applications, there is a need for disposable gas cylinders. Such cylinders may be used for dispensing aerosols, such as deodorants, paint, insecticides, etc. Although such aerosol cans are widely adopted they cannot be used for higher pressures, since both the cans and the valves are typically not designed to hold a pressure exceeding 30 Bars. For comparison, high pressure gas cylinders may store gas at a pressure of 400 Bars or higher.

In certain cases, e.g. when cooling low-cost products, it would be advantageous to store gas at a high pressure, using a container having a simple and cost effective construction. More particularly, there is a need for a disposable container having the possibility to store gas at a pressure up to several hundreds of Bars, and having a non-reversible valve. That is, once the valve is open, it remains open until all gas is discharged from the container. There is also a need for a disposable container having a safety valve withstanding 30 Bars or above and being configured to discharge the content of the cylinder in a controlled manner.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a system according to the appended patent claims.

An idea of the invention is to provide a gas container that may be manufactured in a simple and cost-effective way.

A further idea is to provide a simple and cost-effective valve that may be connected to the gas cylinder.

A yet further idea is to provide a disposable gas cylinder having a valve which is capable of storing gas at a pressure up to several hundreds of Bars.

A still further idea is to provide a disposable gas cylinder and a valve which, when opened, remains open in a controlled manner until the gas is fully discharged.

Another idea is to provide a disposable container having a safety valve and being capable of withstanding a high pressure and allowing controlled discharge.

Another idea is to provide a gas cylinder with no risk for blow-off, i.e. the valve will not be able to leave the cylinder if the pressure inside the cylinder is increased.

Yet another idea is to provide a gas cylinder which allows for filling of liquid phase gases, and being capable of safely storing such gases at varying environmental temperatures.

According to an aspect of the invention, a cylinder for storing pressurized fluid is provided comprising a hollow body formed integrally with a closed bottom end and a closed upper end, a valve having a valve body and an actuator, said valve being arranged at said upper end for allowing gas charging and gas discharging, respectively, wherein said valve is mounted on the inside of said cylinder such that the interior surface of said upper end is sealed against said valve body, and such that said actuator is extending outside said cylinder.

According to a second aspect of the invention, a method for providing a cylinder for storing pressurized fluid from a single metal blank is provided. The method comprises punching said metal blank into a hollow tube having a closed bottom end and an open upper end, arranging a valve inside said hollow tube, said valve having a valve body and an actuator, and sealing the interior surface of said upper end against said valve body such that said actuator is extending outside said cylinder.

The term fluid should in this context be interpreted broadly to cover any substance or chemical compound in gaseous or liquid phase.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is an illustration showing a side view of a gas cylinder according to an embodiment of the present invention;

FIG. 2 is a cross sectional view of a gas cylinder according to an embodiment;

FIG. 3 is a cross sectional view of a gas cylinder according to a further embodiment;

FIG. 4 is a method scheme according to an embodiment; and

FIG. 5 is a perspective view of a gas cylinder according to a yet further embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to a gas cylinder and a valve being capable of storing gas at a high pressure.

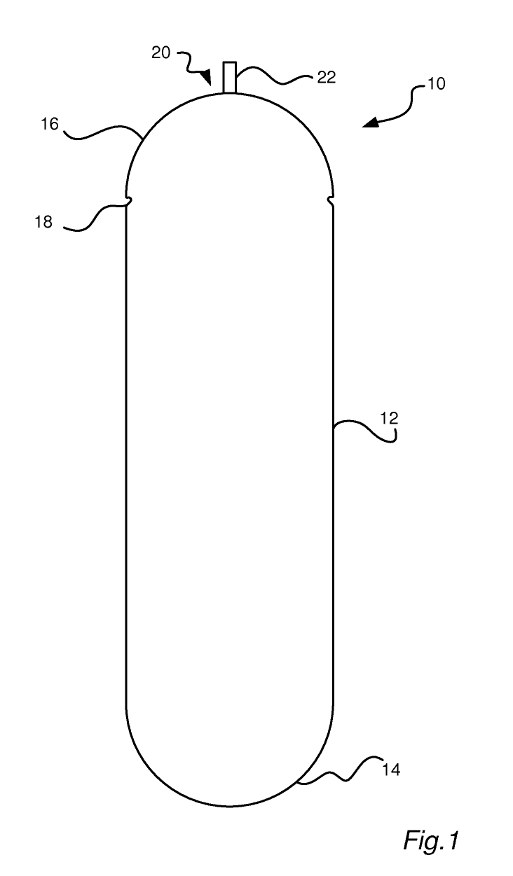

With reference to FIG. 1, a gas cylinder 10 is shown. The cylinder 10 has a tubular body 12, a closed bottom end 14, and a closed upper end 16. The bottom end 14 and the upper end 16 have a spherical shape. A notch 18 is formed at the outer periphery of the tubular body 12 just below the upper end 16.

A valve 20 is arranged inside the cylinder 10, and the valve 20 has an actuator 22 that extends outside the cylinder 10 through an opening at the upper end 16. The valve 20 is opened by applying a force on the actuator 22. When the actuator 22 is pressed downwards towards the cylinder 10, the valve 20 is opened and gas is allowed to escape from the cylinder 10.

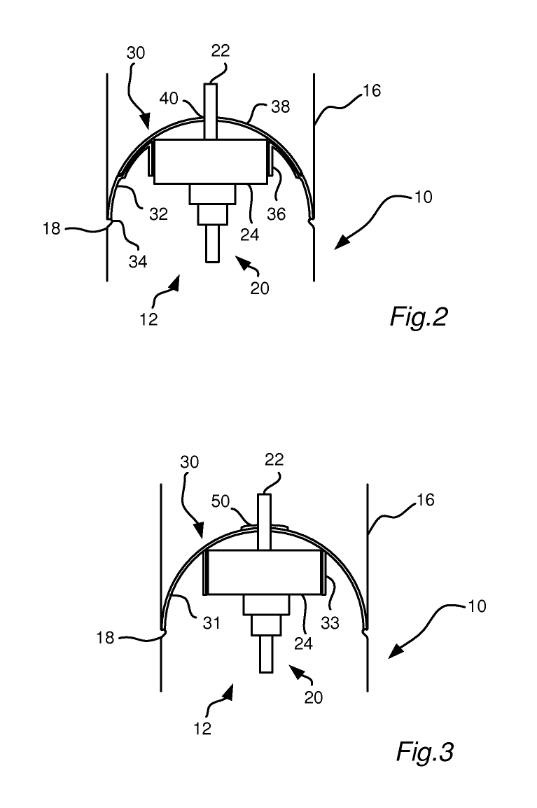

With further reference to FIG. 2, an embodiment of a gas cylinder is partly shown. In this view, the upper end 16 is yet unfolded and the gas cylinder 10 is thus shown in a non-finished state. The valve 20 is located inside the hollow tube 12, and is attached to the interior by means of a two-piece mounting assembly 30. The mounting assembly 30 has a first cup 32 which has a circular base 34, whose diameter corresponds to the interior diameter of the hollow tube 12 such that the first cup 32 may rest on the notch 18. The first cup 32 extends upwardly along a spherical shape until it reaches the main body 24 of the valve 20. A sleeve 36 is formed to engage with the main body 24 of the valve, such that the valve 20 is fixedly attached to the first cup 32. The mounting assembly 30 further comprises a second cup 38, which rests on the first cup 32 and extends upwards having a spherical shape. The second cup 38 has a centre hole 40 at the top, allowing the actuator 22 of the valve to protrude through the centre hole 40. When the upper end 16 is sealed against the mounting assembly 30, the upper end 16 is pressed towards the outer surface of the second cup 38 such that the upper end 16 exhibits a spherical shape. The first cup 32 may also be formed by two spherically shaped portions being formed integral with each other, wherein one of the two portions may have a slightly smaller radius than the other portion. Hence, the two spherically shaped portions may be designed such that the second cup 38 is resting on the portion having a smaller radius. Preferably, the second cup 38 may thus be aligned with the portion of the first cup 32 having a larger radius, such that the two cups 32 and 38 are forming a spherical shape having a common radius. In such embodiment, the second cup 38 covers a surface of the first cup 32 being significantly larger than the non-covered surface of the first cup 32.

In another embodiment, as shown in FIG. 3, the mounting assembly 30 comprises a single cup 31 that has a sleeve 33 for engaging with the valve body 24 such that the cup 31 is fixedly attached to the valve 20. Further, the cup 31 has an upper surface having a spherical shape, such that the upper end 16 of the cylinder 10 exhibits a spherical shape when the upper end 16 is sealed against the mounting assembly 30.

A seal 50 may be provided between the mounting assembly 30 and the upper end 16, to further reduce the risk of gas leakage. The seal 50 may be annular and arranged centrally around the actuator 22. The seal may further extend towards the notch 18, such that the seal 50 covers a portion or the complete area between the mounting assembly 30 and the upper end 16. In a preferred embodiment, the seal 50 is made of a material that does not react with gas stored inside the cylinder 10. The material may in one embodiment be Teflon®.

In a yet further embodiment, the valve is fitted inside a single piece mounting cup. The valve has a valve stem acting as an actuator and extending inside a valve housing. The valve stem has an interior channel which is sealed against the valve housing when the valve stem is in an idle, or non-pressed, mode. When the valve stem is subject to a pressing force in a direction downwards, i.e. towards the valve housing, the interior channel is fluidly connected with the interior of the cylinder such that the content of the cylinder is allowed to be discharged through the interior channel of the valve stem. The mounting cup is formed as a cylindrical piece surrounding the valve housing, and the mounting cup is further equipped with a through hole for allowing the valve stem, or actuator, to protrude outside the mounting cup. Preferably, the cylindrical shape of the mounting cup has a first thickness at its periphery and an increased thickness at its center.

A gasket is formed on top of the mounting cup to form a sealing against the interior surface of the upper end of the cylinder, and to create a stabilizing functionality for the valve/mounting cup assembly. Preferably, the gasket has a lower side being formed to fit the upper surface of the mounting cup. The upper side of the gasket is preferably dome shaped, in order to enable the upper end of the cylinder to adapt to the shape of the gasket to form a corresponding dome shape, or spherical shape. The valve stem, extending outside the valve housing, is also extending outside the gasket.

The gasket may be formed by any suitable material, such as plastic, rubber, or any combination of such materials.

The cylinder may be provided with an annular notch according to what has previously been described. In a further embodiment, the annular notch is replaced by at least two protrusions inside the cylinder. The protrusions may be distributed at the interior surface of the cylinder at a specific distance from the bottom, such that the valve/mounting cup assembly may be centrally aligned. In a yet further embodiment, the cylinder may be equipped with an annular notch as well as at least two protrusions for forming a support structure that the valve/mounting cup assembly may rest upon prior to forming the closed upper end of the cylinder.

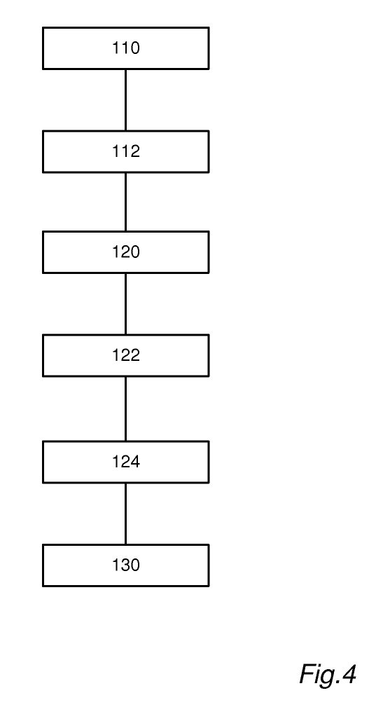

A method 100 for providing a gas cylinder will now be described with reference to FIG. 4. In a first step 110, a metal blank is punched, or extruded into a hollow body having the shape of a tube. In a particular embodiment, the hollow body has a closed bottom end having a spherical, or dome shape. That is, the closed bottom end is a half sphere being integrally formed with the hollow tube. In this step, the upper end is left open.

In a subsequent step 120, a valve is arranged within the walls of the upper end. The valve has a valve body, and a projecting actuator or valve stem that opens the valve when it is depressed. The valve is arranged such that the actuator is facing the opening of the upper end.

In a next step 130, the open upper end is sealed against the valve body such that the upper end is closed while it is conforming to the shape of the valve body. In a preferred embodiment, the valve body has a spherical or dome shape such that the closed upper end will form a half sphere being integrally formed with the hollow tube. During this step, the upper surface is provided with a hole in the centre, through which hole the actuator is protruding.

The valve body may comprise a mounting assembly, wherein the step 120 of arranging the valve further comprises a step 122 of fixedly attaching said mounting assembly to the valve body. The mounting assembly may either be a single piece, having an upper spherical surface, or a two piece assembly wherein the upper piece has a spherical upper surface.

Further, the method 100 may further comprise a step 112 of providing an annular notch on said hollow body, wherein the step 120 of arranging the valve inside said hollow tube comprises arranging said valve body on said annular notch. This is advantageous in that the valve body may rest on the notch, thus eliminating the risk valve body movement during the subsequent step 130, in which the upper end is sealed against the valve body. In this step, the notch may be replaced by at least two protrusions according to what has been described previously. In case of such protrusions, they may be formed by a tool acting from the outside of the cylinder, thus displacing an amount of cylinder material such that said protrusions are formed on the interior surface of the cylinder.

The method 100 may also comprise a step 124 of providing a seal on the valve body, such that an improved sealing is provided between the valve body, or mounting cup/assembly and the closed upper surface.

When the gas cylinder is closed, i.e. the valve is securely attached to the interior of the gas cylinder leaving only the actuator accessible from the outside, the gas cylinder is filled with pressurized fluid. That is, this particular sequence enables that the cylinder is filled via the valve by means of the valve stem, which upon filling is depressed such that the interior channel of the valve stem is in fluid connection with the closed interior of the cylinder. The fluid may be any gas, although a particular embodiment involves environmental friendly gases suitable for cooling applications such as CO₂ or mixtures containing CO₂.

In a yet further embodiment relating to the manufacturing of said cylinder, the cylinder is filled with content prior to closing the cylinder. In the following, a method for providing such pressurized fluid container will be described. In a first step, a cylindrical body is formed having a closed bottom end and an open upper end. The cylindrical body may be formed in any way known per se, preferably by extruding a metal blank into said body. In a following step the cylindrical body is cooled down to a predetermined temperature, preferably by introducing said cylindrical body into a cooled chamber. When the cylindrical body is cooled down to said predetermined temperature, the cylindrical body is filled to a certain amount by liquid or solid content.

The gas may be CO₂, and the predetermined temperature may be a temperature being below the boiling point of CO₂. If CO₂ is used in atmospheric pressure, the predetermined temperature may be −80° C.

After the content is introduced into said cylindrical body, a valve is introduced into said cylindrical body. Preferably, the cylindrical body is provided with a neck, notch, or at least two protrusions being arranged at a position above the liquid or solid content level such that the valve, when introduced, is not in contact with the content of the cylinder.

For this purpose, the valve may comprise a mounting cup that is configured to keep the valve into a centrally aligned position within the cylindrical body. Hence, the mounting cup is resting on said neck, notch, or protrusions.

The step of introducing the valve and the mounting cup inside the cylindrical body is performed at the predetermined temperature, such that the gas remains in liquid or solid phase. Preferably, this step is performed in the same chamber as the filling step.

When the valve is introduced, the cylindrical body is sealed against the valve or the mounting cup. Further, the mounting cup may extend on the upper side of said valve facing the open end of the cylindrical body. This is advantageous in that if the mounting cup exhibits specific shape, the upper end of the cylindrical body will align to that shape. In a preferred embodiment the mounting cup has a spherical or dome shape, either intrinsically or by the aid of a gasket, which means that the cylindrical body, when closed, will also exhibit a spherical shape. This step is performed such that the container, when the cylindrical body is sealed against the valve and/or the mounting cup, encloses the valve except for an actuator or valve stem protruding outside said container.

In this particular step, different additional components may be added such as sealings, coatings, etc.

The step of sealing the cylindrical body is performed at the predetermined temperature, such that the content remains in liquid or solid phase. Preferably, this step is performed in the same chamber as the filling step and the valve insertion step.

As a last step, the sealed container is heated to a temperature above the predetermined temperature, preferably to room temperature. At this point, the pressure inside the gas container is increased. Typically, the container is configured to hold a pressure of 400 Bars or higher. In less demanding application, the container is configured to hold a pressure of up to 90 Bars. For such different applications, the material of the cylindrical body may be varied. However, Al or alloys containing Al are preferred.

It should be mentioned that the present method will be inventive also for other gaseous content such as O₂, N₂, etc.

In an embodiment, a method for providing a pressurized container comprises the steps of: providing a cylindrical body having a closed bottom end and an open upper end, cooling said cylindrical body to a predetermined temperature, filling said cylindrical body to a certain extent with a liquid or solid content, wherein said predetermined temperature is below the boiling point of said content, introducing a valve inside the cylindrical body, and closing said upper end of said cylindrical body by sealing said cylindrical body against the valve, wherein the step of closing the upper end of the cylindrical body is performed at said predetermined temperature.

Further, the gas cylinder may be formed by a single metal blank containing Al, Ni, Cr, or any alloys containing any of these metals. Moreover, the thickness of the walls and ends of the gas cylinder may be designed such that the gas cylinder does not deform due to the high pressure inside the cylinder.

The valve 20 may be any fluid valve known per se specifically constructed to hold a high pressure, and the valve 20 may be equipped with a pressure relief function. In a specific embodiment, the valve 20 may have the same structural components as an aerosol valve, although being modified to withstand a high pressure.

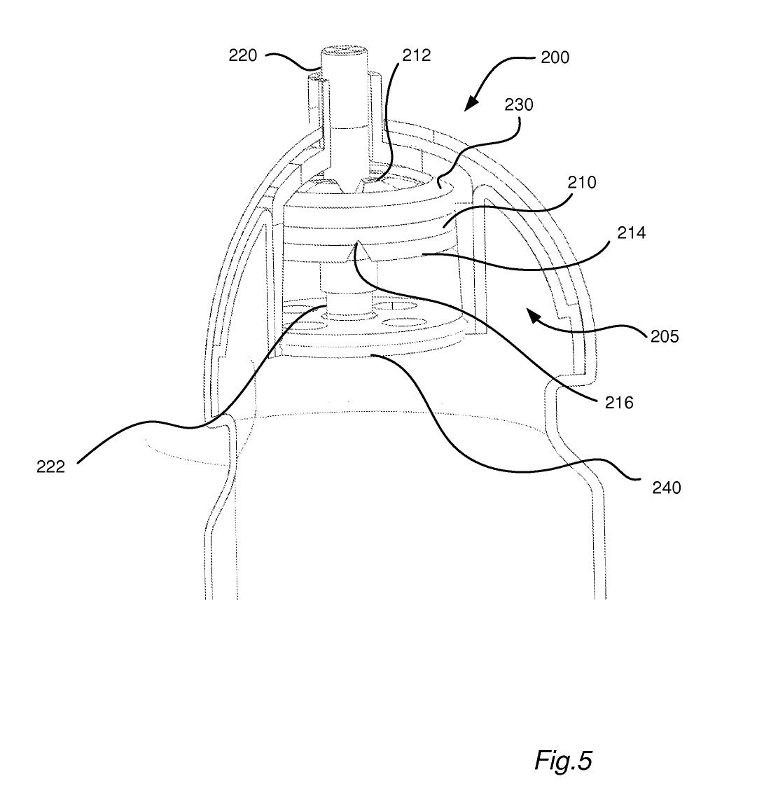

In a further embodiment, the valve may be a disposable valve having built-in pressure relief functionality. The valve 200, being shown in FIG. 5, comprises a valve body 205 having a membrane 210 with an upper surface 212 and a lower surface 214, wherein a protrusive member 220 is arranged on the upper surface 212 and extends in a direction being perpendicular to said upper surface 212. The membrane 210 comprises weakening portions 216, wherein the valve 200 is opened by pressing said protrusive member 220 into a weakening portion 216 of said membrane 210 such that the membrane 210 is perforated.

A sealing 230 may be arranged at the outer periphery of the upper surface 212 of the membrane 210, such that the sealing 230 provides a sealed contact between the valve 200 and the interior surface of a gas cylinder.

Further, the weakening portions 216 may also be provided on the lower surface 214, thus forming recessive grooves on both sides of the membrane 210.

In an embodiment, the valve 200 may further comprise a second protrusive member 222 being arranged on the lower surface 214 and extending in a direction perpendicular to said lower surface 214.

The first and second protrusive members 220, 222 may be formed integrally with the membrane 210.

The valve 200 may further comprise a guiding member 240 connected to the valve housing 205 and being arranged to guide the second protrusive member 222 when the first protrusive member 220 is pressed downwards. The guiding member 240 may be provided with at least one through hole, for allowing fluid to flow through said guiding member 240 during filling and emptying of said gas cylinder. In a specific embodiment, the through holes are provided symmetrically along the periphery of the circularly shaped guiding member. Further, the guiding member 240 is arranged on the interior surface of the valve body 205.

In an embodiment, the interior surface of the valve body 205 may be provided with a plurality of groves extending longitudinally in the same direction as the protrusive members 220, 222.

The functionality of the valve 200 will now be described. The valve 200 is arranged inside a gas cylinder, preferably but not necessarily identical to what has previously been described. Hence, the valve 200 is inventive per se, and may be used for a number of different applications.

The valve 200 is arranged on a neck of the gas cylinder, and is sealed against the interior surface of the upper end by means of a sealing. The first protrusive member, being integrally formed with the membrane, protrudes outside the gas cylinder and is thus accessible for a user. Also, the valve housing extends outside the gas cylinder and surrounds the first protrusive member.

When the gas cylinder is being filled with gas, a gas source is tightly connected to the valve housing. When the gas source is opened, the gas will be allowed to flow between the valve housing and the first protrusive member. The high pressure will thus urge the membrane to move inwardly, such that a small slit is formed between the membrane and the interior of the valve housing. The sealing will in this situation not provide a pressure tight sealing between the membrane and the valve housing, and the gas cylinder may be filled.

When filling is completed, the gas source is closed and the pressure inside the gas cylinder will press the membrane in an upward direction, such that a pressure tight sealing is achieved between the valve housing and the interior surface of the upper end of the gas cylinder, as well as between the membrane and the valve housing. When the gas cylinder encloses pressurized gas, an equal pressure will be distributed on the lower surface of the membrane. The membrane is thus designed such that the weakening portions can hold a predetermined pressure, and will burst when the pressure inside the gas cylinder exceeds that value. Hence, the valve 200 may be opened in two different ways, namely:

1) When the pressure inside the gas cylinder exceeds a predetermined value, e.g. due to increased temperature, the weakening portions will burst and gas will be discharged.

2) When a user presses the first protrusive member, a pressure will be applied at a weakening portion located at the centre of the membrane. Since the protrusive member is tapered such that the apex of the protrusive member is facing the weakening portion, the force will be applied only to a small surface. A user may thus provide a pressing force to penetrate the membrane, and the gas is discharged.

The apex may for example be 1 mm², such that a pressure of 300 Bar corresponds to an applied force of approximately 30 N. In other embodiments, the apex may be less than 1 mm².

The part of the valve housing being located outside the gas cylinder may be threaded, such that a further valve may be connected to the gas cylinder. In a particular embodiment, the valve is configured such that the first protrusive member is pressed when a second valve is connected to the valve.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way. Further, any reference to “upper”, “lower”, “right”, or “left” are made only as relative determinations. It should thus be realized that such references do not limit the scope of the claims.

1. A cylinder for storing pressurized fluid, comprising:
a hollow body formed integrally with a closed bottom end and a closed upper end,
a valve having a valve body and an actuator, said valve being arranged at said upper end for allowing gas charging and gas discharging, respectively, wherein
said valve is mounted on the inside of said cylinder such that the interior surface of said upper end is sealed against said valve body, and such that said actuator is extending outside said cylinder.

2. The cylinder according to claim 1, wherein said bottom end has a spherical shape, and said upper end has a spherical or dome shape.

3. The cylinder according to claim 1, wherein said valve body comprises a mounting cup to which it is securely attached to, and wherein said upper end is conforming to the shape of said mounting cup.

4. The cylinder according to claim 3, wherein said mounting cup comprises a first part and a separate second part, said first part being securely attached to said valve body, and said second part being arranged adjacent to said first part such that the upper end is conforming to the shape of the second part.

5. The cylinder according to claim 3, wherein the hollow tube comprises an annular notch onto which the mounting cup is arranged.

6. The cylinder according to claim 1, further comprising an annular seal being arranged between the valve body and the interior surface of the upper end.

7. The cylinder according to claim 1, wherein said valve is an aerosol valve.

8. The cylinder according to claim 1, further comprising a locking means connectable with said actuator, wherein said locking means is configured to hold the actuator in a depressed position when the actuator is depressed for allowing gas discharging.

9. The cylinder according to claim 1, wherein said valve body comprises a membrane, wherein said membrane is perforated upon activation of said valve.

10. A method for providing a cylinder for storing pressurized fluid from a single metal blank, said method comprising:
punching said metal blank into a hollow tube having a closed bottom end and an open upper end,
arranging a valve inside said hollow tube, said valve having a valve body and an actuator, and
sealing the interior surface of said upper end against said valve body such that said actuator is extending outside said cylinder.

11. The method according to claim 10, wherein the step of punching said metal blank comprises forming said bottom end into a spherical or dome shape, and wherein the step of sealing said upper end comprises forming said upper end into a spherical or dome shape.

12. The method according to claim 10, further comprising the step of providing an annular notch on said hollow body, wherein the step of arranging the valve inside said hollow tube comprises mounting said valve body on said annular notch.
